(19) United States
(12) Patent Application Publication
(10) Pub. No.: US 2026/0334686 A1
(43) Pub. Date: Oct. 29, 2026

(54) ERGONOMIC ARMREST ACCESSORY DEVICE FOR VEHICLES

(71) Applicant: Marc Bain, Charlotte, NC (US)

(72) Inventor: Marc Bain, Charlotte, NC (US)

(21) Appl. No.: 19/655,893

(22) Filed: Apr. 23, 2026

Related U.S. Application Data
(60) Provisional application No. 63/794,441, filed on Apr. 25, 2025.

(51) Int. Cl. A47C 7/54; A47C 7/62; B60N 2/75

(52) U.S. Cl. CPC A47C 7/546; A47C 7/62; B60N 2/787

(57) ABSTRACT

An ergonomic armrest accessory device for vehicles is attached to a vehicle door configured to allow a driver's arm to be placed on a covered cushion of the armrest accessory and alleviate pain from the arm.

### CROSS-REFERENCE TO RELATED APPLICATIONS

This application claims the benefit of U.S. Provisional Application No. 63/794,441, filed on Apr. 25, 2025, which is hereby incorporated in its entirety.

### FIELD OF THE INVENTION

The present invention is directed to an ergonomic armrest accessory device for vehicles configured for removable installation and transportation. More particularly, the device is configured to alleviate pain from points which results from a user sitting in one position for extended periods of time.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Commercial drivers spend many hours behind the wheel in one position, thus creating pain points, a common occurrence by contacting the hard factory plastic door panel for extended periods. This occurrence can be highly uncomfortable for vehicle drivers, which can cause specific ailments, such as chronic pain. Joseph, Leonard, et al. Prevalence of Musculoskeletal Pain among Professional Drivers: A Systematic Review. Journal of Occupational Health, vol. 62, no. 1, 2020.

Currently, most conventional armrests are fixedly installed in vehicles and are not designed for easy removal or replacement. Many of these conventional armrests are not designed to accommodate for the driver of a vehicle, especially truck drivers. Furthermore, conventional armrests are often placed in the middle console, leaving no cushion for the left side of a driver in modern vehicles (see, for example, U.S. Pat. No. 8,403,416 B2). Although these devices are armrests, they are providing minimal support for the driver and are permanently installed so they cannot be removed or adjusted.

Therefore, there exists a need for an armrest accessory device tailored specifically to vehicles.

### SUMMARY OF THE INVENTION

The present invention is directed to an ergonomic armrest accessory device for vehicles. This invention is intended to facilitate an ergonomic armrest accessory device that connects to vehicle door panels in a quick and simple fashion. The present invention is easy to use, quick and easy to install, and freely removable from vehicle door panels. Furthermore, the present invention provides comfort and relief to vehicle drivers while on long drives in one position.

In an embodiment, ergonomic armrest accessory device comprises a cushion comprising a top side and a bottom side; a base comprising a top side and a bottom side; and a mounting apparatus comprising a top panel, a left side panel, and a right side panel. The bottom side of the cushion is attached to the top side of the base. The top panel of the mounting apparatus is attached to the bottom side of the base. The left side panel of the mounting apparatus extends vertically from one end of the top panel and the right side panel of the mounting apparatus extends vertically from the opposite end of the top panel. The left side panel and the right side panel of the mounting apparatus each comprise a plurality of horizontal cutouts, wherein the plurality of horizontal cutouts are positioned near end of the left side panel and the right side panel that is furthest from the top panel.

In another embodiment, the ergonomic armrest accessory device comprises a plurality of straps configured for securing the device, wherein the plurality of straps are threaded through the plurality of horizontal cutouts of the mounting apparatus.

In yet another embodiment, the cushion of the ergonomic armrest accessory device comprises foam, silicon, silicon grid, or any combination thereof.

In one embodiment, the base of the ergonomic armrest accessory device comprises metal, plastic, wood, or any combination thereof.

In another embodiment, the mounting apparatus of the ergonomic armrest accessory device comprises metal, plastic, wood, or any combination thereof.

In yet another embodiment, the base and the cushion are connected by silicone adhesive, small wire, and or hook-and-loop tape.

In another embodiment, the base and the mounting apparatus are connected by plurality of screws, and or bolts.

In one embodiment, the ergonomic armrest accessory device comprises a cover, wherein the cover is configured to envelope the cushion, and the cover comprises cotton, silk, polyester, synthetic fiber, or any combination thereof.

In another embodiment, the cover is configured to extend to wrap around the cushion and the base.

In still another embodiment, the cover is attached to the bottom side of the base with screws, bolts, and or hook-and-loop tape.

In one embodiment, the ergonomic armrest accessory device is removably attached to a vehicle door.

In another embodiment, the ergonomic armrest accessory device is removably attached to an armrest.

In yet another embodiment, the ergonomic armrest accessory device comprises a cushion comprising a top side and a bottom side; and a base comprising a top side and a bottom side, wherein the bottom side of the cushion is attached to the top side of the base.

Various objects, features, aspects, and advantages of the inventive subject matter will become more apparent from the following detailed description of exemplary embodiments, along with the accompanying figures in which like numerals represent like components.

### BRIEF DESCRIPTION OF THE DRAWINGS

FIG. 1 is an exemplary configuration of an ergonomic armrest accessory device for vehicles while detached from vehicle.

FIG. 2 is an exemplary configuration of a bottom view of the ergonomic armrest accessory device for vehicles.

FIG. 3 is an exemplary configuration of a left-side view of the ergonomic armrest accessory device for vehicles.

FIG. 4 is an exemplary configuration of a front view of the ergonomic armrest accessory device for vehicles.

FIG. 5 is an exemplary configuration of a right-side view of the ergonomic armrest accessory device for vehicles.

FIG. 6 is an exemplary configuration of the ergonomic armrest accessory device for vehicles, as in situ, when attached to a vehicle armrest.

FIG. 7 is an exemplary configuration of an alternative embodiment of the ergonomic armrest accessory device for vehicles.

FIG. 8 is an exemplary configuration of a side view of an alternative embodiment of the ergonomic armrest accessory device for vehicles.

FIG. 9 is an exemplary configuration of a front view of an alternative embodiment of the ergonomic armrest accessory device for vehicles.

FIG. 10 is an exemplary configuration of an ergonomic armrest accessory device for vehicles, as in situ, when attached to a vehicle door panel.

### DETAILED DESCRIPTION

The present invention is directed to an ergonomic armrest accessory device for vehicles configured to provide vehicle drivers relief to their arms and elbows while on long drives. The present invention accomplishes this relief while being inexpensive to manufacture and easy to use.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “about” in conjunction with a numeral refers to a range of that numeral starting from 10% below the absolute of the numeral to 10% above the absolute of the numeral, inclusive.

As used herein, the terms “device” and “ergonomic armrest accessory for vehicles” are used interchangeably.

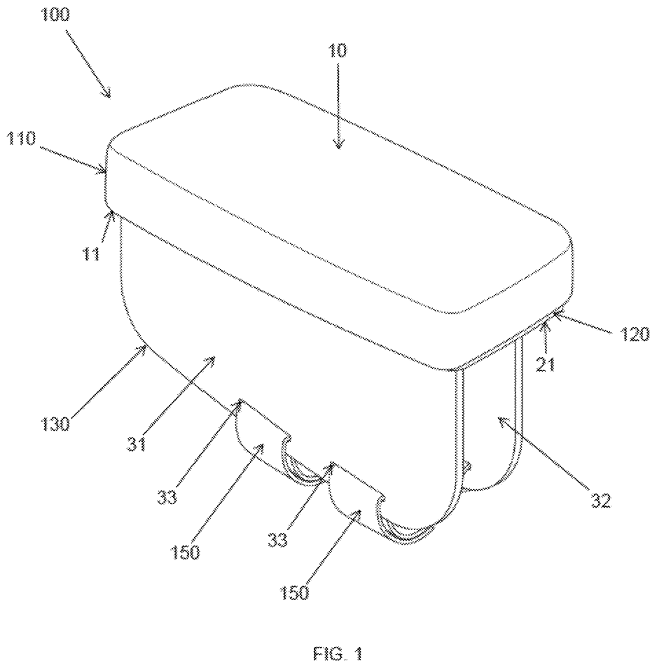

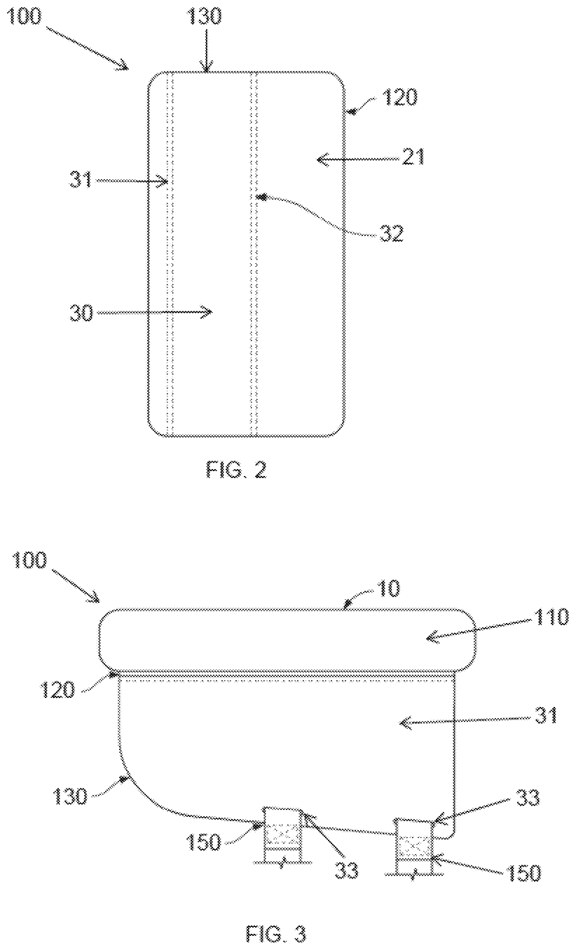

FIG. 1 is an exemplary embodiment of device 100 comprising cushion 110, base 120, and mounting apparatus 130. In one embodiment, cushion 110 comprises bottom side 11 and base 120 comprises top side 20 and bottom side 21. In an embodiment, mounting apparatus 130 comprises top panel 30 (see FIG. 2), left side panel 31, right side panel 32, and horizontal cutouts 33 designed for securing device 100 to a vehicle. In one embodiment, bottom side 11 of cushion 110 connects to top side 20 of base 120. In an embodiment, bottom side 21 of base 120 connects to top panel 30 of mounting apparatus 130. In an exemplary embodiment, cushion 110 and base 120 may be connected by silicone adhesive, small wire, hook and loop tape, or other suitable means of attachment. In a preferred embodiment, cushion 110 and base 120 are connected with silicone adhesive. In an embodiment, base 120 and mounting apparatus 130 may be connected by screws or bolts or other suitable means of attachment. In a preferred embodiment, base 120 and mounting apparatus 130 are connected with screws. In one embodiment, mounting apparatus 130 comprises a plurality of horizontal cutouts 33, through which straps 150 may be threaded, for securing device 100 to a vehicle door.

In one embodiment, mounting apparatus 130 comprises a variety of configurations, including inverted U-shaped, L-shaped, T-shaped, C-shaped, ring-shaped, circular, rectangular, oval, hook-shaped, saddle-shaped, V-shaped, Y-shaped, curved, flat, or dome-shaped structures. In a preferred embodiment, mounting apparatus 130 is an inverted U-shaped.

In an embodiment, cushion 110 comprises foam, silicon, silicon grid, or any combination thereof. In a preferred embodiment, cushion 110 comprises silicon grid. In one embodiment, base 120 comprises metal, plastic, or wood or any combination thereof. In a preferred embodiment, base 120 comprises wood. In an embodiment, mounting apparatus 130 comprises metal, plastic, or wood. In a preferred present embodiment, mounting apparatus 130 comprises metal.

In an exemplary embodiment, device 100 includes cover 140 designed to cover top side 10 of cushion 110. In a preferred embodiment, device 100 comprises cover 140 designed to cover top side 10 of cushion 110. In one embodiment, cover 140 comprises cotton, silk, polyester, synthetic fiber, or any combination thereof. In a preferred embodiment, cover 140 is made of synthetic fiber. In one embodiment, cover 140 is configured to extend to wrap around cushion 110 and base 120. In a preferred embodiment, cover 140 is configured to extend to wrap around cushion 110 and base 120. In another embodiment, bottom side 40 of cover 140 may go under bottom side 21 of base 120. In a preferred embodiment, bottom side 40 of cover 140 is located under bottom side 21 of base 120. In one embodiment, cover 140 is attached to bottom side 21 of base 120 with screws, bolts, or hook and loop tape. In a preferred embodiment, cover 140 is connected to bottom side 21 of base 120 with hook and loop tape.

In an exemplary embodiment, device 100 comprises an insulator including rubber, silk, rayon, or any combination thereof. In a preferred embodiment, insulator is made of rubber. In an embodiment, top side of insulator is attached to internal walls of mounting apparatus 130.

FIG. 2 is an exemplary bottom-view embodiment of device 100 depicting top panel 30, left side panel 31, right side panel 32 of mounting apparatus 130 and bottom side 21 of base 120.

FIG. 3 is an exemplary left side-view of device 100 depicting cushion 110, base 120, left side panel 31 of mounting apparatus 130, and a plurality of horizontal cutouts 33 designed for securing device 100 to a vehicle. In this embodiment, a plurality of straps 150 are threaded through a plurality of horizontal cutouts 33.

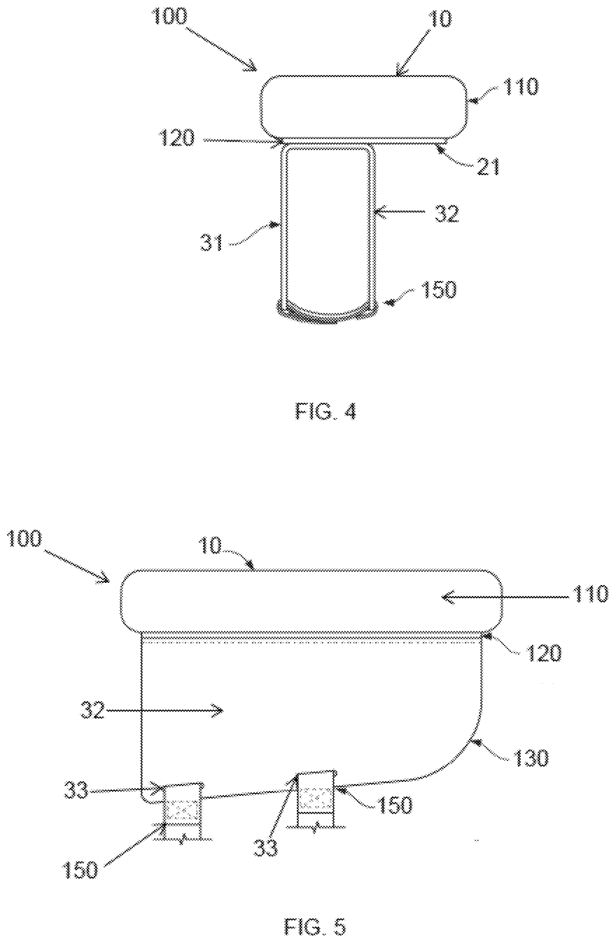

FIG. 4 is an exemplary front-view embodiment of device 100 depicting cushion 110 attached to base 120 and base 120 attached to top panel 30 of mounting apparatus 130. In an embodiment, a plurality of straps 150 threaded through horizontal cutouts 33 of left side panel 31 and right side panel 32 of mounting apparatus 130 thereby securing device 100 to a vehicle.

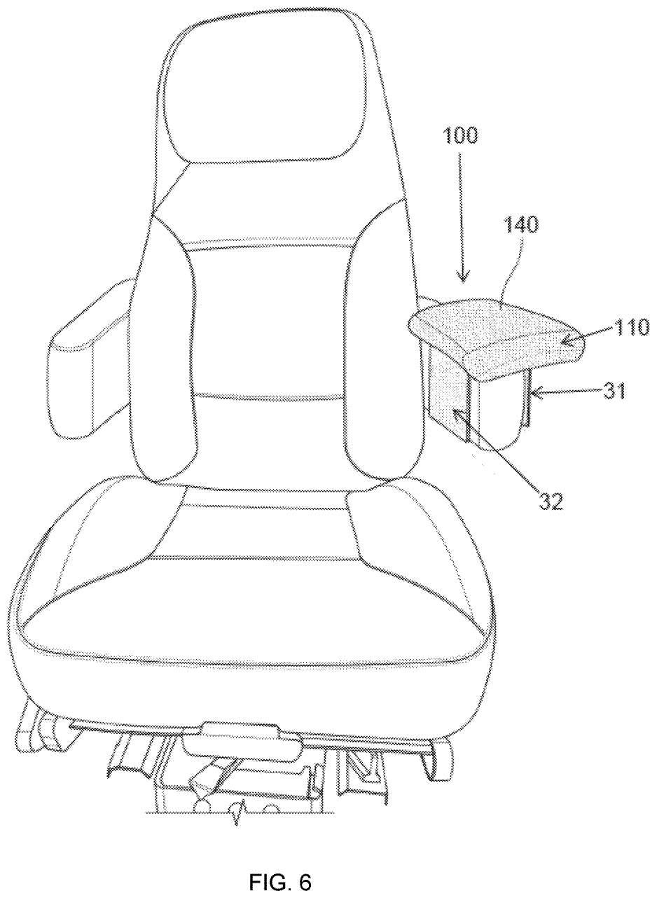

FIG. 5 is an exemplary right side-view embodiment of device 100 depicting. cushion 110, base 120, right side panel 32 of mounting apparatus 130, plurality of horizontal cutouts 33, and plurality of straps 150 designed for securing device 100.

FIG. 6 is an exemplary embodiment of device 100, as in situ, when attached to an armrest depicting cushion 110, left side panel 31 of mounting apparatus 130, and right side panel 32 of mounting apparatus 130.

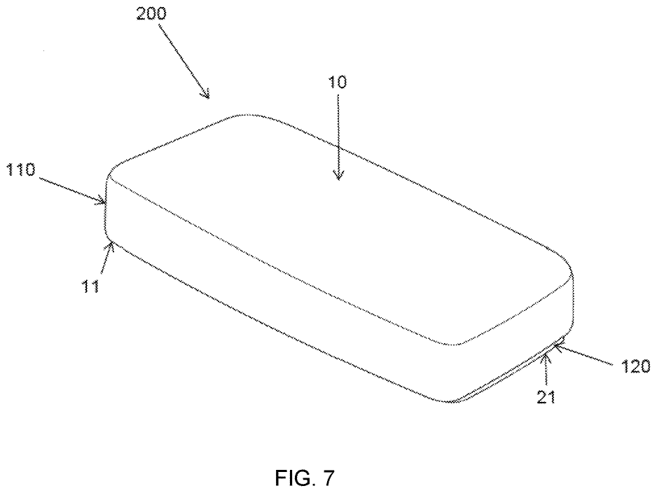

FIG. 7 is an exemplary configuration of an alternative embodiment of device 200 comprising cushion 110 and base 120. In one embodiment, cushion 110 comprises top side 10 and bottom side 11, and base 120 comprises top side 20 and bottom side 21. In one embodiment, bottom side 11 of cushion 110 connects to top side 20 of base 120. In an embodiment, bottom side 21 of base 120 connects to a vehicle. In an exemplary embodiment, cushion 110 and base 120 may be connected by silicone adhesive, small wire, hook and loop tape, or other suitable means of attachment. In an alternative embodiment, cushion 110 and base 120 are connected with silicone adhesive. In an exemplary embodiment, base 120 may be connected to vehicle by hook and loop tape or other suitable means of attachment. In an embodiment, base 120 is attached to vehicle by hook and loop tape.

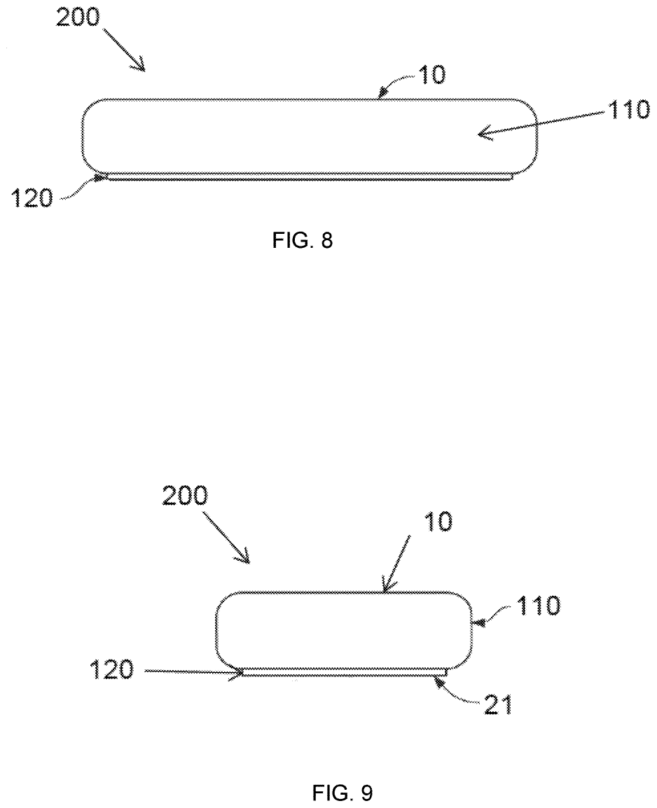

FIG. 8 is an exemplary side view of device 200 depicting cushion 110 and base 120.

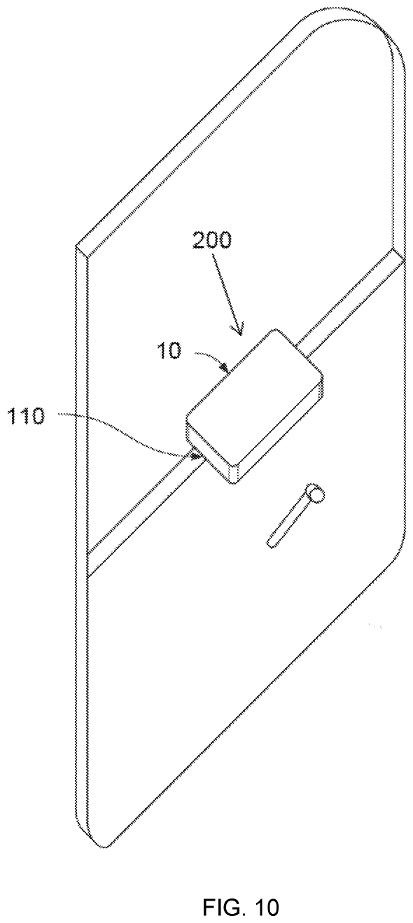

FIG. 9 is an exemplary front view of device 200 depicting cushion 110 and base 120.

FIG. 10 is an exemplary embodiment of device 200, as in situ, depicting device 100 connected to a vehicle door. In this embodiment, device 200 rests on panel of a vehicle door.

Thus, specific embodiments of an ergonomic armrest accessory device for vehicles and methods to employ such armrest accessory have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An ergonomic armrest accessory device comprising:
a. a cushion comprising a top side and a bottom side;
b. a base comprising a top side and a bottom side; and
c. a mounting apparatus comprising a top panel, a left side panel, and a right side panel,
wherein
i. said bottom side of said cushion is attached to said top side of said base;
ii. said top panel of said mounting apparatus is attached to said bottom side of said base;
iii. said left side panel of said mounting apparatus extends vertically from one end of said top panel and said right side panel of said mounting apparatus extends vertically from the opposite end of said top panel; and
iv. said left side panel and said right side panel of said mounting apparatus each comprising a plurality of horizontal cutouts, wherein said plurality of horizontal cutouts are positioned near end of said left side panel and said right side panel that is furthest from said top panel.

2. The ergonomic armrest accessory device according to claim 1, further comprising a plurality of straps configured for securing said device, wherein said plurality of straps are threaded through said plurality of horizontal cutouts of said mounting apparatus.

3. The ergonomic armrest accessory device according to claim 1, wherein said cushion comprises foam, silicon, silicon grid, or any combination thereof.

4. The ergonomic armrest accessory device according to claim 1, wherein said base comprises metal, plastic, wood, or any combination thereof.

5. The ergonomic armrest accessory device according to claim 1, wherein said mounting apparatus comprises metal, plastic, wood, or any combination thereof.

6. The ergonomic armrest accessory device according to claim 1, wherein said base and said cushion are connected by silicone adhesive, small wire, and or hook-and-loop tape.

7. The ergonomic armrest accessory device according to claim 1, wherein said base and said mounting apparatus are connected by plurality of screws, and or bolts.

8. The ergonomic armrest accessory device according to claim 1, further comprising a cover, wherein
a. said cover is configured to envelope said cushion; and
b. said cover comprises cotton, silk, polyester, synthetic fiber, or any combination thereof.

9. The ergonomic armrest accessory device according to claim 8, wherein said cover is configured to extend to wrap around said cushion and said base.

10. The ergonomic armrest accessory device according to claim 8, wherein said cover is attached to said bottom side of said base with screws, bolts, and or hook-and-loop tape.

11. The ergonomic armrest accessory device of claim 1, wherein said device is removably attached to a vehicle door.

12. The ergonomic armrest accessory device of claim 1, wherein said device is removably attached to an armrest.

13. An ergonomic armrest accessory device comprising:
a. a cushion comprising a top side and a bottom side; and
b. a base comprising a top side and a bottom side,
wherein
i. said bottom side of said cushion is attached to said top side of said base.

14. The ergonomic armrest accessory device of claim 13, wherein said device is removably attached to a vehicle door.
